(19) United States
(12) Patent Application Publication
(10) Pub. No.: US 2016/0124395 A1
(43) Pub. Date: May 5, 2016

(54) WRIST-WATCH TYPE FLEXIBLE DISPLAY DEVICE

(71) Applicant: Young Yi LEE, Gyeonggi-do (KR)

(72) Inventor: Young Yi LEE, Suwon-si, Gyeonggi-do (KR)

(21) Appl. No.: 14/897,168

(22) PCT Filed: Oct. 10, 2014
(86) PCT No.: PCT/KR2014/009527

§ 371 Date: Dec. 9, 2015

(30) Foreign Application Priority Data
Oct. 16, 2013 (KR) 10-2013-0123283
Aug. 27, 2014 (KR) 10-2014-0112197

(51) Int. Cl. G04G 17/04; G06F 1/16

(52) U.S. Cl. CPC G04G 17/045; G06F 1/163

(57) ABSTRACT

A wrist watch type flexible display device, or more specifically, a wrist type display device having a flexible display which is rotatable and convertible between bent state and un-bent state, is provided.

Accordingly, a wrist watch type display device includes a wrist band, a flexible display, a main body comprising a circuit and an electronic component embedded therein, a rotational engagement member engaged with a lower surface of the flexible display to rotate the flexible display, a flex adjustment member formed on the lower surface of the flexible display to be bent or un-bent, thus causing the flexible display to be interactively bent or un-bent, and a string member embedded in the flex adjustment member to be pulled and released, thus causing the flex adjustment member to be interactively bent or un-bent.

### TECHNICAL FIELD

The present disclosure relates to a wrist watch type flexile display device, and more particularly, to a wrist watch type display device including a flexible display which is rotatable and is convertible between bent state and un-bent state.

### BACKGROUND ART

Most people use smartphones or tablet PCs employing full touchscreens. The full touchscreen smartphones or tablet PCs are portable devices that are very convenient to use and helpful, since users can use all the functions by touching with their fingers.

However, since the currently-available smartphones or tablet PCs require touchscreen of a predetermined size to receive finger touches, this causes inconvenience to users in carrying the devices in their hands.

Recently, smartwatches have been developed, which are types of smartphones wearable on user's wrists. The smartwatches are in wrist watch form and some are configured such that displays are curved along watchstraps.

While the smartwatches are wearable on wrists and provide advantageously enhanced portability, there are limits in the touchscreen size, and disadvantage that one has difficulty of seeing the flexible displays underside the wrist.

Accordingly, to increase marketability of the smartwatch and expand user base, the smartwatch will have to be provided with a touchscreen in a similar size as that of the existent smartphone.

Further, currently-available flexible display product is provided only in partly bendable form, due to difficulty of integrating the flexile display with a battery or a circuit element.

### DISLOSURE OF INVENTION

### Technical Problem

An object of the present disclosure is to solve the problems mentioned above, and accordingly, it is an object of the present disclosure to provide a wrist watch type display device capable of providing an effect of a touchscreen in a similar size as that of the existent smartphone.

Another object of the present disclosure is to provide a wrist watch type flexible display device which allows a user to have an overall look around the flexible display while in bent state, thus removing inconvenience of the user when watching a screen.

Another object of the present disclosure is to provide a wrist watch type display device, with which a user is free to change a direction of the display and bend or un-bend the display without having to release a wrist watch band.

### Solution to Problem

According to the present disclosure, a wrist watch type flexible display device includes a wrist band, a flexible display, a main body comprising a circuit and an electronic component embedded therein, a rotational engagement member engaged with a lower surface of the flexible display to rotate the flexible display, a flex adjustment member formed on the lower surface of the flexible display to be bent or un-bent, thus causing the flexible display to be interactively bent or un-bent, and a string member pulled and released on the flex adjustment member, thus causing the flex adjustment member to be interactively bent or un-bent.

The rotational engagement member interacts with the string member so that, when the upper member is rotated according to a rotational movement of the rotational engagement member, the string member is released, thus causing the flex adjustment member to un-bend, and when the upper member is rotated reversely, the string member is pulled, thus causing the flex adjustment member to bend, so that simultaneously upon rotation, the flexible display is converted from bent state into un-bent state, and then converted from the un-bent state into the bent state.

Further, according to the present disclosure, a wrist watch type flexible display device includes a wrist band, a flexible display, a main body comprising a circuit and an electronic component embedded therein, a rotational engagement member engaged with a lower surface of the flexible display to rotate the flexible display, and a flex adjustment member formed on the lower surface of the flexible display to be bent or un-bent interactively with the rotation of the rotational engagement member, thus causing the flexible display to be bent or un-bent, in which when the rotational engagement member is rotated, the flex adjustment member is bent or un-bent, thus causing the flexible display to rotate and simultaneously convert from the bent form into the un-bent form and then convert from the un-bent form into the bent form.

Further, according to the present disclosure, a wrist watch type flexible display device includes a flexible display, a main body including a circuit and an electronic component embedded therein, a rotational connecting member engaged with a lower surface of the flexible display to rotate the flexible display, and a string member formed on the lower surface of the flexible display to be pulled and released, thus causing the flex adjustment member to be bent or un-bent.

Further, according to the present disclosure, a wrist watch type flexible display device includes a wrist band, a flexible display wrapped around the wrist band, and a flex adjustment member formed on a lower surface of the flexible display to be bent or un-bent, thus causing the flexible display to be interactively bent or un-bent.

Further, according to the present disclosure, a wrist watch type flexible display device includes a wrist band, a main body including a circuit and an electronic component embedded therein, and a flexible display wrapped around the wrist band, to be converted from a bent form into an un-bent form and then converted from the un-bent form into the bent form.

### Advantageous Effects of Invention

As described above, according to the present disclosure, it is possible to change a direction of a display without having to release a wrist band, and since a flexible display is converted from a state of being wrapped along the wrist band in bent form into a state of being un-bent, an effect of maximized screen size can be provided.

Further, according to the present disclosure, since the flexible display in the un-bent state is rotated to a direction linear to arms and hands, this allows the user to watch the screen in a horizontal orientation with a wider screen width, and accordingly, the user can experience new style of screen and see the screen of increased overall size.

Further, according to the present disclosure, since component such as a battery or a circuit board that is currently considered to be the technical obstacle to flexibility is separated, the performance as same as that of the flexible product and that exceeds the curved product can be realized by partially implementing flexibility.

### BRIEF DESCRIPTION OF DRAWINGS

FIG. 1 illustrates a wrist watch type display device according to the present disclosure.

FIG. 2 illustrates a rotating structure and a flex structure of a wrist watch type display device according to an embodiment of the present disclosure.

FIG. 3 illustrates a rotating structure and a flex structure of a wrist watch type display device according to another embodiment of the present disclosure.

FIG. 4 illustrates a rotational structure of a wrist watch type display device according to an embodiment of the present disclosure.

FIG. 5 illustrates a rotational structure of a wrist watch type display device according to another embodiment of the present disclosure.

FIG. 6 illustrates a flex structure of a wrist watch type display device according to another embodiment of the present disclosure.

FIG. 7 illustrates a flexible printed circuit board (FPCB) installed on a flexible display according to an embodiment of the present disclosure.

FIGS. 8 to 10 illustrate a flex structure of a wrist watch type display device according to yet another embodiment of the present disclosure.

FIG. 11 illustrates a rotational structure of a wrist watch type display device according to yet another embodiment of the present disclosure.

### MODE FOR THE INVENTION

The preferred embodiments will be explained in greater detail below with reference to the drawings attached hereto. The embodiments of the present disclosure may have a variety of modifications. Accordingly, the scope of the present disclosure should not be limited to the embodiments described in detail below. The embodiments are provided herein to more fully explain the present disclosure for understanding of those with average knowledge in the pertinent art. Accordingly, certain elements may be exaggerated in their shapes or the like in the drawings for increased clarity of the explanation. Note that the same elements in the respective drawings may be referred to by the same reference numerals. The known functions and constitutions may not be described in detail herein, when determined that these may obscure the concept of the present disclosure.

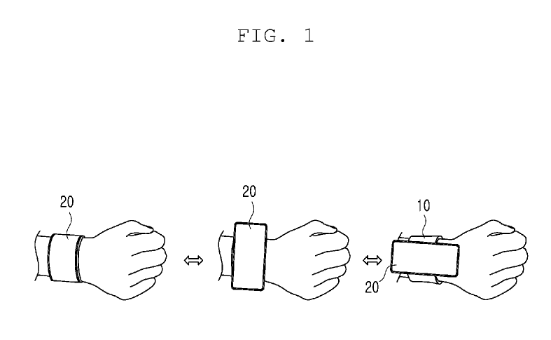

FIG. 1 illustrates a wrist watch type display device according to the present disclosure.

Referring to FIG. 1, a wrist watch type display device includes a wrist band 10 and a flexible display 20.

The flexible display 20 has a structure such that it is converted from the bent state to un-bent state without requiring a user to release the wrist band, thus allowing the user to watch a screen underside the wrist with increased accuracy and convenience.

That is, the flexible display 20 in the bent state on the wrist band 10 may be changed from the state of wrapping around the wrist band 10 to the released state by user's manual operation or mechanical or electric method, and may rotate again to the position in the linear direction of the arm and hand.

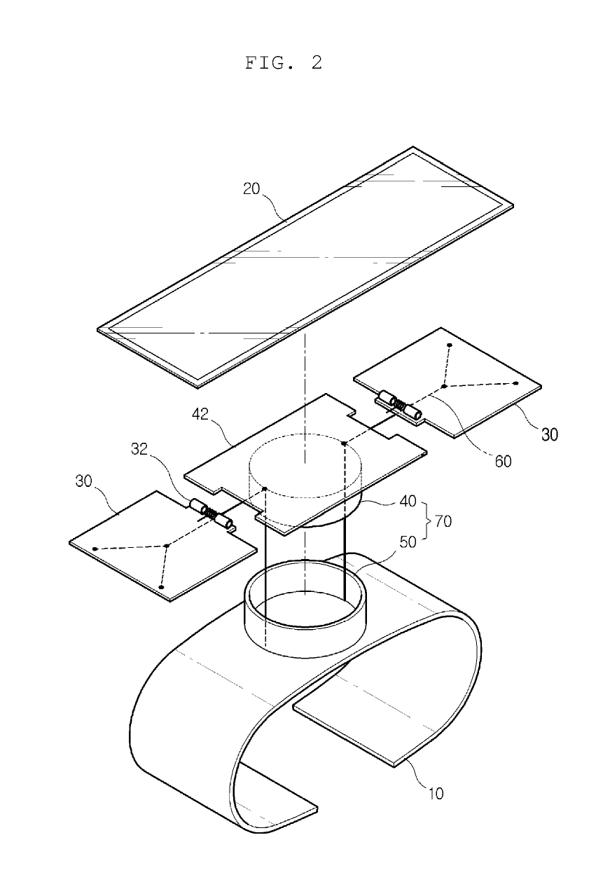

The structure of the flexible display 20 converting from the bent state to the un-bent state and then rotating, will be described with reference to FIGS. 2 to 6.

FIG. 2 illustrates a rotating structure and a flex structure of a wrist watch type display device according to an embodiment of the present disclosure.

Referring to FIG. 2, an upper member 40 is formed at a lower center of the flexible display 20. Flex adjustment members 30 are formed on both lower ends of the flexible display 20, and a lower member 50 is formed on the wrist band 10 to correspond to the upper member 40.

The flex adjustment members 30 are bent or un-bent, thus allowing the flexible display 20 to be bent or un-bent. Further, a string member 60 is formed on the flex adjustment member 30 so that the flex adjustment members 30 are bent or un-bent interactively with the string member 60 as the string member 60 is pulled or released mechanically or electrically.

The pathway for the string member 60 to move may include elastic member, and the elastic member allows effective control on release and pulling of the string member 60.

As illustrated in FIG. 2, the flex adjustment members 30 may be formed on both lower ends of the flexible display 20, and coupled with a plate 42 of the upper member 40 with an engagement member 32, although embodiments are not limited thereto. For example, the plate 42 of the upper member 40 and the flex adjustment members 30 may be configured independently or integrally, with a plurality of joints joined with each other.

The engagement member 32 for engaging the plate 42 of the upper member 40 with the flex adjustment members 30 may include an elastic body, and the elastic body allows more efficient control on bending and un-bending of the flex adjustment members 30.

The upper member 40 and the lower member 50 are configured to rotate relative with each other. A rotational engagement member 70 is configured by coupling of the upper member 40 and the lower member 50. The upper member 40 includes respective circuits and electric parts embedded therein integrally with the main body.

A portion of the string member 60 is formed on the flex adjustment member 30, and the rest extends to a direction of the rotational engagement member 70.

Further, the rotational engagement member 70 interacts with the string member 60 such that in response to rotation of the upper member 40, the string member 60 is released from the tightened state, thus allowing the flex adjustment members 30 to un-bend. In contrast, in response to the rotation of the upper member 40 in the opposite direction, the string member 60 is pulled from the released state, thus causing the flex adjustment members 30 to bend. Accordingly, simultaneously upon rotating, the flexible display 20 is convertible from bent state to un-bent state, and then from un-bent state to the bent state.

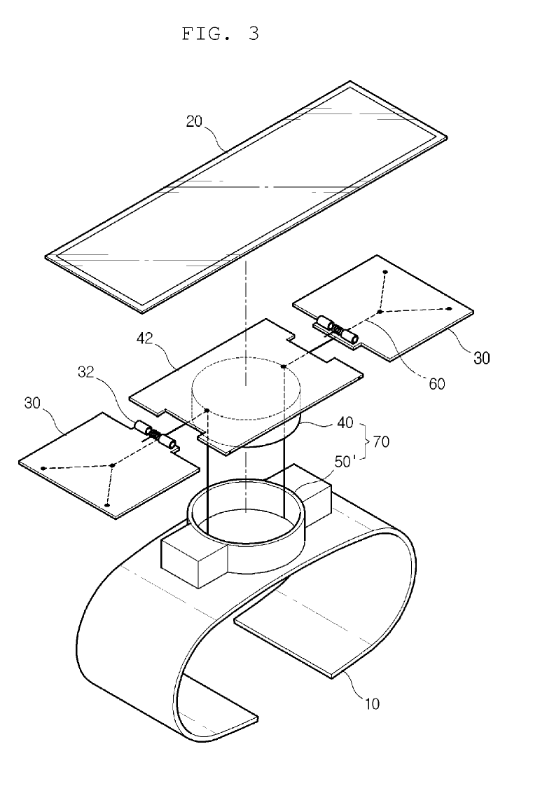

FIG. 3 illustrates a rotating structure and a flex structure of a wrist watch type display device according to another embodiment of the present disclosure.

The rotating structure and the flex structure illustrated in FIG. 3 is almost identical to that illustrated in FIG. 2, except that the main body with the respective circuits and electric parts embedded therein is formed in the lower member 50′, instead of the upper member 40.

In a structure in which the upper member 50 is inserted into the lower member 50′ and rotated, the lower member 50′ may have a shape different from the lower member 50 illustrated in FIG. 2, to ensure a space necessary for accommodating the respective circuits or electric parts therein.

As described, the rotating structure and the flex structure can adjust direction and bending state of the display without requiring a user to release the wrist band, thus enabling the user to expand and operate the screen with increased ease.

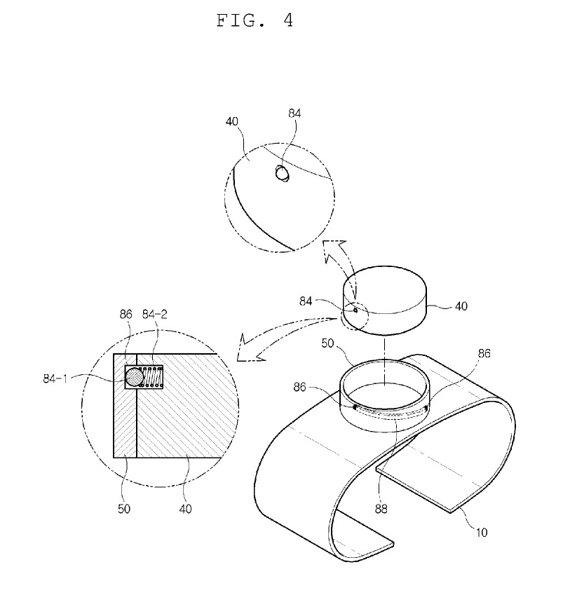

FIG. 4 illustrates in detail a rotational structure of a wrist watch type display device according to an embodiment of the present disclosure.

Referring to FIG. 4, the rotational engagement member 70 is a structure that rotates with a user's physical force. Accordingly, with force exerted to the rotational engagement member 70, the upper member 40 rotates within the lower member 50.

A locking protrusion 84 is formed on an outer wall of the upper member 40, locking holes 86 are formed on an inner wall of the lower member 50, and a moving path 88 is formed between the locking holes 86. The locking protrusion 84 moves along the moving path 88 and, upon being locked into the locking hole 86, stops moving. The moving path 88 may be formed in a spiral shape as illustrated in FIG. 4, for example.

The locking protrusion 84 may be a stationary protrusion which is integrally formed on an outer wall, or alternatively, a movable protrusion which is combined with an elastic body such as a spring so as to be entered or exited by the elastic body.

In the configuration described above, as the rotational engagement member 70 is subject to force, the locking protrusion 84 is separated from the locking hole 86 and moved along the moving path 88, so that the flexible display 20 is rotated. The locking protrusion 84 is moved to a location at which the locking hole 86 is formed and fixed by the locking hole 86.

Specifically, the movable locking protrusion 84 includes a spring 84-2 inserted in an outer wall thickness of an upper member 40, and a locking bead 84-1 engaged with the spring 84-2 and protruded on the outer wall.

In such structure, as the upper member 40 is subject to pressure, the locking bead 84-1 is compressed by the spring 84-2 so as to be moved downward along the spiral moving path 88 until it enters into the locking hole 86 and stops moving.

Next, when the pressure is lifted off, the locking bead 84-1 is separated from the locking state in the locking hole 86, and thus is moved upward along the spiral moving path 88 to return to the initial position.

The locking structure described above is not limited to the specific example provided above. Accordingly, a variety of manners may be employed such as, for example, by moving or fixing by way of engaging two relative objects.

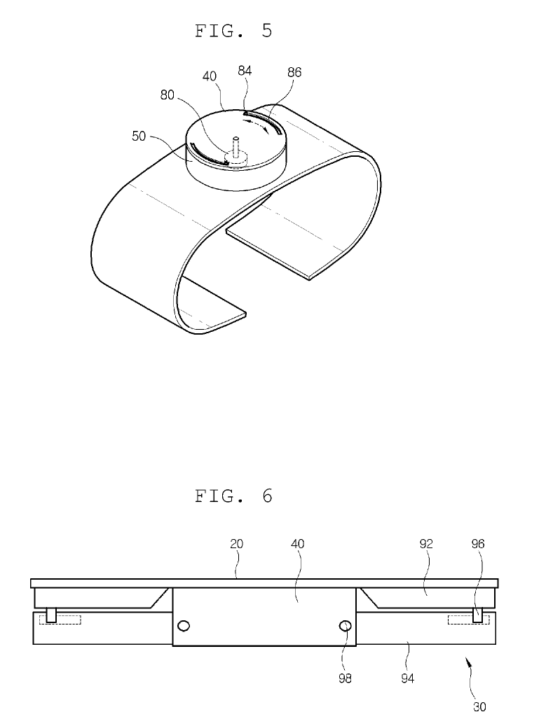

FIG. 5 illustrates a rotational structure of a wrist watch type display device according to another embodiment of the present disclosure.

Referring to FIG. 5, the upper member 40 on the lower member 50 is engaged with the lower member 50 as a relatively rotating structure. By the rotational structure of a combination of the upper member 40 with the lower member 50, the upper member 40 is rotated laterally on the lower member 50, and there is a rotational controller 80 provided to control the rotation.

The locking protrusion 84 is fixedly formed on the lower member 50, and the locking holes 86 to receive the locking protrusion 84 are formed on the upper member 40.

The upper member 40 is rotated on the lower member 50, but rotated by a length of the locking hole 86 as it stops rotating by the locking protrusion 84. According to such rotation of the rotational engagement member 70, the flexible display 20 may be rotated laterally by a predetermined angle.

In addition to the examples described above, the rotational engagement member 70 may have a variety of other configurations based on a variety of combinations of the upper member 40 and the lower member 50 according to shapes thereof to allow relative rotation and rotation to a predetermined position. Further, the rotational engagement member 70 may be configured to be rotated by not only electric energy, but also artificial force.

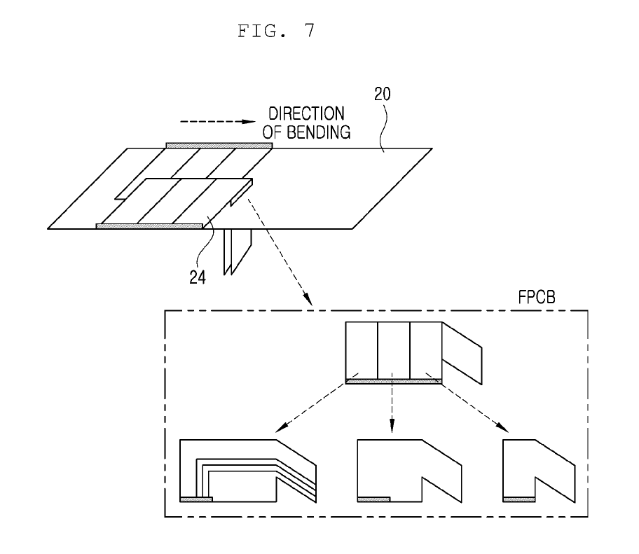

FIG. 6 illustrates a flex structure of a wrist watch type display device according to another embodiment of the present disclosure.

Referring to FIG. 6, the flex adjustment member 30 includes a first flex adjustment portion 92 engaged with a lower surface of the flexible display 20, and a second flex adjustment portion 94 engaged with the upper member 40. The first flex adjustment portion 92 and the second flex adjustment portion 94 are engaged with each other in a movable locking combination structure.

When the second flex adjustment portion 94 is moved about an engagement shaft 98 of the upper member 40, by the locking structure, the first flex adjustment portion 92 is moved together. As a result, the flexible display 20 may be turned from un-bent state into bent state, and then from bent state into un-bent state. The locking structure may include a length changing member 96 so as to respond to changes in length which may occur due to flex adjustment.

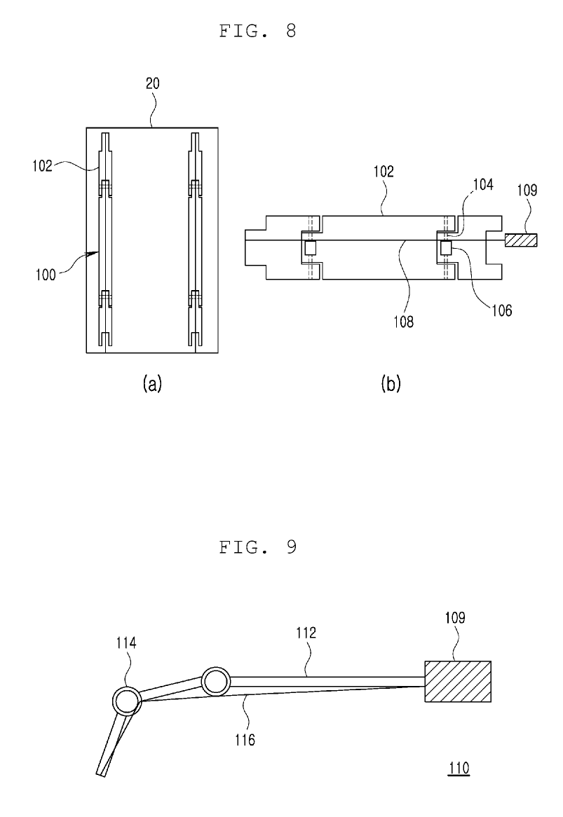

FIG. 7 illustrates a flexible printed circuit board (FPCB) installed on a flexible display according to an embodiment of the present disclosure.

Referring to FIG. 7, a plurality of flexible printed circuit boards (FPCBs) 24 are stacked on one another on the flexible display 20.

The FPCBs 24 are designed such that these are drawn from a center of rotation of the flexible display 20 and bend at both ends of the flexible display 20. Accordingly, performance of the flexible display device can be enhanced, since the circuit boards, for which flexibility is hardly achievable, are designed efficiently.

Meanwhile, referring to FIG. 2, a string member 60 is used as a string to adjust flexion of the flex adjustment member 30. However, the string member 60 may be directly formed on the lower surface of the flexible display 20, rather than being formed on the flex adjustment member 30.

Accordingly, as the string member 60 is pulled and released, the flexible display 20 is moved in association therewith to thus directly turn from the bent state into un-bent state, or from un-bent state into bent state.

As described above, the flexible display 20 may be bent or un-bent by the interaction between the flex adjustment member 30 and the string member 60, or bent and un-bent by the string member 60 alone. However, embodiments are not limited to the examples provided above. Accordingly, the flex adjustment member 30 may use only the material having restoring force, or may be configured in a variety of forms.

The flexible display 20 may also be formed of a material having restoring force, in which case the flexible display 20 may be bent or un-bent with its own restoring force, and without requiring the flex adjustment member 30 or the string member 60.

Locking structures (not illustrated) may be formed on both ends of the flexible display 20 to allow attachment and detachment to and from the wrist band 10. According to the locking structures, the flexible display may maintain the state of bending and wrapping around the wrist band 10.

When the locking structures are released mechanically or electrically, both ends of the flexible display 20 are released from the wrist band 10, turning into un-bent state. In order to turn this from the un-bent state into bent state, a user may grab, manually, both ends of the flexible display 20 and bend the same so that the flexible display 20 is fixed to the wrist band 10 by the locking structures.

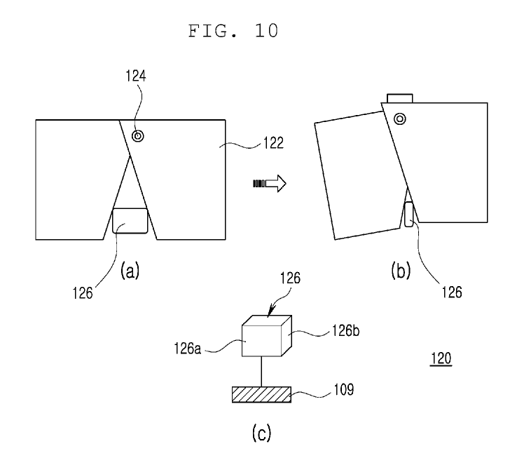

FIGS. 8 to 10 illustrate a flex structure of a wrist watch type display device according to yet another embodiment of the present disclosure.

The flex adjustment member 100 illustrated in FIG. 8 is formed on the lower surface of the flexible display 20. Further, although not illustrated herein, locking structures may be formed on both ends of the flex adjustment member 100 to allow attachment and detachment of the wrist band 10.

As illustrated in FIG. 8, there may be flex adjustment members 100 disposed on left and right sides of the flexible display 20, but embodiments are not limited thereto. Accordingly, the flex adjustment member 100 may be disposed only at a center of the flexible display 20, or disposed in a different form.

The flex adjustment member 100 includes a plurality of segments 102, in which the segments 102 are rotatably engaged with one another by a connector. The segment connector, which engages the respective segments with one another, includes an engagement shaft 104 allowing the segments to rotate about the shaft, and a spring 106 to restore the bent segment into linear form. The segments 102 are provided with a flex adjustment string 108 to bend or un-bend the segments 102, and the flex adjustment string 108 bends or un-bends the flex adjustment member 100 as it is pulled and released mechanically or electrically by the flex adjustment controller 109.

Meanwhile, the segments 102 may be bent manually, i.e., without requiring the flex adjustment string 108 or the adjustment controller 109, and restored into linear form by a spring.

The flex adjustment member 110 illustrated in FIG. 9 is formed on the lower surface of the flexible display 20, and includes linear-type segments 112, with each of the segments 112 being supported on a segment connector 114. The segment connector 114 may have a spring structure to restore the linear-type segment 112 from the bent state back to the linear state.

A flex adjustment string 116 is formed at the linear-type segment 112 to be bent or un-bent the linear-type segment 112, and the flex adjustment string 116 causes the flex adjustment member 110 to be bent or un-bent while being pulled and released by the flex adjustment controller 109 mechanically or electrically.

Again, it is possible to bend the segment 112 and restore the same to the linear form manually, i.e., without requiring the flex adjustment string 116 or the adjustment controller 109.

The flex adjustment member 120 illustrated in FIG. 10 is formed on the lower surface of the flexible display 20, and includes a plurality of segments 122 engaged by a spring structure 124.

In order to be bent or un-bent the segments 112, a flex adjustment pin 126 is formed at a space between the respective segments, and the flex adjustment pin 126 causes the flex adjustment member 120 to be bent or un-bent while being rotated to a different position by the flex adjustment controller 109 mechanically or electrically.

The flex adjustment pin 126 is so formed that it has a long surface 126a and a short surface 126b. When the long surface 126a is positioned in front, the flex adjustment pin 126 maintains a linear form as the segments are spaced apart from each other. When the short surface 126b is positioned in front, the flex adjustment pin 126 is changed to the bent form as the distance between segments is narrowed by the restoring force of the spring structure 124. The degree of bending may be adjusted according to the shape of the segments 122 or the size of the flex adjustment pin 126.

As described above, the flex adjustment member 100, 110, 120, which may include a plurality of segments, or alternatively, may not be divided into segments or formed into a specific shape, is formed on the lower surface of the flexible display 20 and bent or un-bent mechanically or electrically, causing the flexible display 20 to be interactively bent or un-bent.

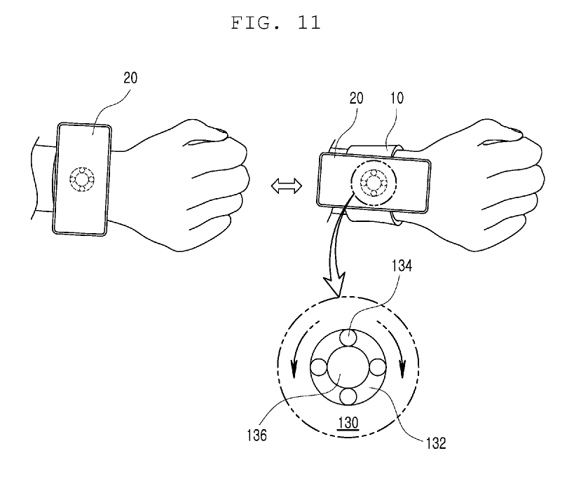

FIG. 11 illustrates a rotational structure of a wrist watch type display device according to yet another embodiment of the present disclosure.

Referring to FIG. 11, the rotational engagement member 130 includes a rotational support 132 fixedly formed on the wrist band 10, a rotational mover 134 slidably moving on the rotational support 132, and a path 136 through which a circuit line passes and which electrically engages the flexible display 20 with the circuit board.

The rotational support 132 is fixedly formed on the wrist band 10, and the rotational mover 134 is formed on the flexible display 20. Accordingly, the flexible display 20 is rotated according to the sliding movement of the rotational mover 134. The rotational support 132 may include stoppers (not illustrated) at every 90 degrees so that the rotational mover 134 is fixed from rotating at 90 degree intervals by the stopper.

The foregoing embodiments and advantages are merely exemplary and are not to be construed as limiting. The present teaching can be readily applied to other types of apparatuses. Also, the description of the embodiments is intended to be illustrative, and not to limit the scope of the claims, and many alternatives, modifications, and variations will be apparent to those skilled in the art.

### INDUSTRIAL APPLICABILITIY

The present disclosure relates to a flexible display which is rotatable and is convertible between bent state and un-bent state, and a wrist watch type display device having the same, which are widely applicable to touchscreen-based smart watch products.

1. A wrist watch type display device, comprising:
a wrist band;
a flexible display;
a main body comprising a circuit and an electronic component embedded therein;
a rotational engagement member engaged with a lower surface of the flexible display to rotate the flexible display;
a flex adjustment member formed on the lower surface of the flexible display to be bent or un-bent, thus causing the flexible display to be interactively bent or un-bent; and
a string member pulled and released on the flex adjustment member, thus causing the flex adjustment member to be interactively bent or un-bent.

2. The wrist watch type display device of claim 1, wherein the rotational engagement member comprises an upper member formed on the lower surface of the flexible display, and a lower member formed on the main body, and the upper member and the lower member are engaged as a relatively rotating structure.

3. The wrist watch type display device of claim 1, wherein the rotational engagement member comprises an upper member integrated with the main body and formed on the lower surface of the flexible display, and a lower member engaged with the wrist band, and the upper member and the lower member are engaged as a relatively rotating structure.

4. The wrist watch type display device of claim 2, wherein the rotational engagement member interacts with the string member so that
when the upper member is rotated according to rotational movement of the rotational engagement member, the string member is released, thus causing the flex adjustment member to un-bend, and
when the upper member is rotated reversely, the string member is pulled, thus causing the flex adjustment member to bend, so that
simultaneously upon rotation, the flexible display is converted from bent state into un-bent state, and then converted from the un-bent state into the bent state.

5. The wrist watch type display device of claim 2, wherein a locking protrusion is formed on the upper member and locking holes are formed on the lower member, or the locking holes are formed on the upper member and the locking protrusion is formed on the lower member, with a moving path formed between the locking holes so that
when the rotational engagement member is subject to pressure, the locking protrusion is moved along the moving path, thus causing the flexible display to rotate.

6. The wrist watch type display device of claim 2, wherein the flex adjustment member comprises a first flex adjustment portion engaged with the lower surface of the flexible display, and a second flex adjustment portion engaged with the upper member,
the first flex adjustment portion and the second flex adjustment portion are engaged with each other in a movable locking combination structure, so that
when the second flex adjustment portion is moved about an engagement shaft of the upper member, by the locking structure, the first flex adjustment portion is moved together, thus causing the flexible display to convert from the un-bent form into the bent form and then from the bent form into the un-bent form.

7. A wrist watch type display device, comprising:
a wrist band;
a flexible display;
a main body comprising a circuit and an electronic component embedded therein;
a rotational engagement member engaged with a lower surface of the flexible display to rotate the flexible display; and
a flex adjustment member formed on the lower surface of the flexible display to be bent or un-bent interactively according to the rotation of the rotational engagement member, thus causing the flexible display to be bent or un-bent, wherein when the rotational engagement member is rotated, the flex adjustment member is bent or un-bent, thus causing the flexible display to rotate and simultaneously convert from the bent form into the un-bent form and then convert from the un-bent form into the bent form.

8. A wrist watch type display device, comprising:
a flexible display;
a main body comprising a circuit and an electronic component embedded therein;
a rotational connecting member engaged with a lower surface of the flexible display to rotate the flexible display; and
a string member formed on the flex adjustment member to be pulled and released, thus causing the flex adjustment member to be bent or un-bent.

9. A wrist watch type display device, comprising:
a wrist band;
a flexible display wrapped around the wrist band; and
a flex adjustment member formed on a lower surface of the flexible display to be bent or un-bent, thus causing the flexible display to be interactively bent or un-bent.

10. A wrist watch type display device, comprising:
a wrist band;
a main body comprising a circuit and an electronic component embedded therein; and
a flexible display wrapped around the wrist band, to be converted from a bent form into an un-bent form and then converted from the un-bent form into the bent form.

11. The wrist watch type display device of claim 9, further comprising a rotational engagement member formed between the flexible display and the wrist band to rotate the flexible display.

12. The wrist watch type display device of claim 11, comprising locking structures on both ends of the flexible display, which are attachable to and detachable from the wrist band.

13. The wrist watch type display device of claim 3, wherein the rotational engagement member interacts with the string member so that
when the upper member is rotated according to rotational movement of the rotational engagement member, the string member is released, thus causing the flex adjustment member to un-bend, and
when the upper member is rotated reversely, the string member is pulled, thus causing the flex adjustment member to bend, so that
simultaneously upon rotation, the flexible display is converted from bent state into un-bent state, and then converted from the un-bent state into the bent state.

14. The wrist watch type display device of claim 3, wherein a locking protrusion is formed on the upper member and locking holes are formed on the lower member, or the locking holes are formed on the upper member and the locking protrusion is formed on the lower member, with a moving path formed between the locking holes so that
when the rotational engagement member is subject to pressure, the locking protrusion is moved along the moving path, thus causing the flexible display to rotate.

15. The wrist watch type display device of claim 3, wherein the flex adjustment member comprises a first flex adjustment portion engaged with the lower surface of the flexible display, and a second flex adjustment portion engaged with the upper member,
the first flex adjustment portion and the second flex adjustment portion are engaged with each other in a movable locking combination structure, so that
when the second flex adjustment portion is moved about an engagement shaft of the upper member, by the locking structure, the first flex adjustment portion is moved together, thus causing the flexible display to convert from the un-bent form into the bent form and then from the bent form into the un-bent form.

16. The wrist watch type display device of claim 10, further comprising a rotational engagement member formed between the flexible display and the wrist band to rotate the flexible display.

17. The wrist watch type display device of claim 16, comprising locking structures on both ends of the flexible display, which are attachable to and detachable from the wrist band.
